(19) United States
(12) Patent Application Publication
(10) Pub. No.: US 2005/0041783 A1
(43) Pub. Date: Feb. 24, 2005

(54) Communications methods and systems using voiceprints

(76) Inventors: Timothy A. Timmins, Tigard, OR (US); John S. Miller, Canby, OR (US); Nathan B. Baker, Tigard, OR (US); Christopher A. Huey, Banks, OR (US); Philip A. Ljubicich, Lake Forest Park, WA (US)

Correspondence Address: ALEX L. YIP;KAYE SCHOLER LLP, 425 PARK AVENUE, NEW YORK, NY, 10022, US

(21) Appl. No.: 10/957,817

(22) Filed: Oct. 4, 2004

Related U.S. Application Data
(62) Division of application No. 10/403,207, filed on Mar. 31, 2003.

(51) Int. Cl. H04M 1/64

(52) U.S. Cl. 379/88.02

(57) ABSTRACT

In communications systems where multiple users may be associated with the same account, the voiceprint of a user is used to identify a profile of the user, facilitating identification of the user's preferences without requesting additional information from the user. The system may also monitor messages played to individual users, to control the playing of the messages to users. Calls made by users associated with the same account may be allocated to the caller initiating the call in bills, based on voiceprints. Voiceprints may be collected for use in deriving voiceprint samples during registration of a user with the system and during conversations between the user and the system. A voiceprint comparison threshold may be set based on the type of phone calling the system, to compensate for noise. Changes in phone numbers and/or addresses of users are monitored and the threshold is adjusted if changes are found.

### FIELD OF THE INVENTION

The invention relates to communications methods and systems and, more particularly, communications methods and systems using voiceprints. The communications system may be an information assistance service system, for example.

### BACKGROUND OF THE INVENTION

It is a common experience to use a telephone or similar device to call an operator for information assistance. In a typical information assistance call, a caller identifies to the operator the name and address (sometimes city or area code) of a party whose telephone number is desired. In response, the operator locates the desired destination number using a computer database, for example. The destination number is then provided to the caller. The number may be provided by a computerized voice server which provides automated voicing of the number. The caller may be afforded an option to be connected to the destination number without the need of first terminating the information assistance call.

It should be noted that even though a user may subscribe to a telephone service provided by a particular carrier (e.g., AT&T Wireless Services Inc.) or branding partner (e.g., Virgin), the information assistance service accessed through the telephone service may be contracted by the carrier to a third party, and is therefore run by an independent contractor. That is, carriers may contract different independent providers to provide information assistance services for them. When a subscriber to the carrier makes an information assistance call by dialing such typical access digits as “411,” “*555,” “555-1212,” “00,” “1-800-555-1212,” etc., because of the contractual relationship, the carrier would switch such an information assistance call to its contracted information assistance service provider to handle the call.

Independent providers may provide different information assistance services and service features in addition to directory assistance. For example, upon request, an operator may provide a user with information on regional restaurants, movie listings, and directions to various places and the ability to purchase goods and services, etc. The assignee of the present application is an information assistance service provider which provides, among others, personalized services and special service features, which are different or lacking from other providers. For instance, one such service feature is a StarBack® service feature described in U.S. Pat. No. 5,797,092, whereby a caller, after being connected to a desired party, may be connected back to the assistance service provider by pressing a “*” key on their telephone, or otherwise issuing a command (e.g., saying the word “operator”). Examples of the assignee's personalized services include private directory assistance service and foreign language directory assistance service, which are described, for example, in U.S. Pat. No. 5,966,437 and International Publication No. WO 01/35621.

Users may therefore be motivated to subscribe to independent information service providers for directory assistance and the other offered services. Users may pay the independent information service provider at the time of the call for that call, by credit card, for example, or may establish subscription accounts, facilitating their use of the system.

When a subscriber to an independent information service provider calls the service from a wireline phone, the service may identify the originating phone based on identifiers in the call set-up signals associated with the call, such as an Automatic Number Identifier (“ANI”). If a wireless phone is used, the identifier may be the phone number, also known as a Mobile Identification Number (“MIN”) of the wireless phone. If the phone is registered with the service in association with the subscriber and/or the subscriber's account, identification of the phone initiating the call may enable identification of the subscriber, as well. Instead of identifying the phone calling the system, the system might identify a customer account. For example, a business customer may obtain a unique phone number to access the communications service for use by authorized parties under the business account. In that case, a dialed number identification service (“DNIS”) string in the call-set-up signals may be used to identify the account with which the caller is associated.

To verify that the caller is the subscriber associated with the registered phone or account, an operator or voice response unit (“VRU”) may ask the caller to provide user verification information, such as a personal identification number “PIN”). Providing a PIN each time the service is called can be annoying and time consuming. In addition, certain customers may have trouble remembering their PIN. To verify the identity of the caller, the operator may then have to ask for additional information, such as the subscriber's name, address, mother's maiden name, credit card number, etc., which the customer may have provided during registration with the system. This may embarrass and annoy the subscriber, as well as be even more time consuming.

In addition, if multiple parties are associated with a subscriber's account, such as family members or employees of a business, use of the ANI may enable identification of the account, but will not enable identification of which one of the multiple parties to the account is calling. As discussed above, an operator or VRU may request additional information to identify the caller, such as a PIN, however, use of a PIN may be problematic.

Communications systems, such as information assistance service systems and network carriers, may provide promotional and informational messages to subscribers, as well as information about the subscriber's account, during a communication with a customer. The message may be played when the subscriber calls the system or carrier, or at the conclusion of a call. To avoid saturating a subscriber with the same message, which may be annoying, the message may only be played periodically, such as every 5 calls, for example. If multiple parties are associated with an account, however, messages may not be evenly distributed among the parties to the account. Parties who use the service more often may hear the message more frequently than the system desires, while less frequent users may hear the message less often. The use of such messages may therefore be less effective for the system and more annoying to certain customers.

Attributing individual calls in a bill for telecommunications services to particular accounts is known in the art. For example, law firms may attribute particular calls to particular clients by inputting a client code after inputting the telephone number. Joint members of a corporate account with a telecommunications service may attribute calls to an individual member through use of a unique PIN number for each member. However, as discussed above, use of a PIN may be problematic.

Voice recognition has been used to assist in identifying a customer of a communications system, as described in U.S. Pat. No. 6,327,345 B1, for example. A voiceprint of a caller may be compared to a stored voiceprint sample based on a voiceprint previously provided by a party. For example, a voiceprint sample may be derived from verbal utterances of the party provided during a registration process. The party may be asked to repeat a password or phrase multiple times, which the system records and processes into a voiceprint sample. The result of the comparison of the voiceprint and the voiceprint sample may be a score indicative of the degree of correspondence between the voiceprint and the voiceprint sample, which may be compared to a threshold. If the threshold is met or exceeded, the party providing the voiceprint is considered to be the same party that provided the voiceprint sample.

The score may be affected by the quality of the call itself, which may reflect the source of the call. For example, a wireless phone and a speakerphone may have more inherent noise and background noise than a wireline phone. Authentic callers may therefore fail the voiceprint test because of noise due to the phone and environment.

### SUMMARY OF THE INVENTION

Improvements in the processing and use of voiceprints in communications methods and systems are disclosed.

In accordance with one embodiment of the invention, a method of operating a communications system is disclosed wherein a plurality of users of the system may be associated with an account with the system and the account has a plurality of voiceprint samples or models corresponding to at least some of the plurality of users associated with the account. The method comprises receiving a call from one of a plurality of users associated with an account, and identifying a preference of the one of the plurality of users based, at least in part, on a voiceprint of the user. The preference may be a limit on messages played to the subscriber. One or more phones may be registered with the account, as well.

In accordance with an aspect of this embodiment, a method of operating a communications system is disclosed comprising receiving a call from one of a plurality of users associated with an account and identifying a profile of one of the plurality of users stored by the system based, at least in part, on a voiceprint of the one user received in the call. The method further comprises monitoring a number of calls since a prior message was played to the user and playing a message if the number of calls since the prior message is at a predetermined number. The predetermined number may be selected by the system, a user associated with the account or by the user. The limit may be a frequency of playing the message to the user, a total number of times the message is played to the user and a type of message played to the user.

In accordance with another aspect of this embodiment of the invention, a communications system is disclosed comprising an interface to receive signals to establish a call connection with one of a plurality of users associated with an account and a processor coupled to the interface. The processor is programmed to identify a profile of the user based, at least in part, on a voiceprint of the user and identify a preference of the user associated with the profile. The preference may be related to related to message limits, for example.

In accordance with another embodiment of the invention, a method of operating a communications system is disclosed, wherein a plurality of users of the system may be associated with an account with the system and the account has a plurality of voiceprint samples corresponding to at least some of the plurality of users associated with the account. The method comprises receiving a call from one of a plurality of users associated with an account and inserting an identifier of the one of the plurality of users into an event record for the call based, at least in part, on a voiceprint of the user. Billing records and bills may therefore be generated wherein calls are allocated to individual users associated with the account. The identifier may be a name of the user, a personal identification number of the user, a business department name or a business department number, for example. The event records may be sent to a billing platform for compilation.

In accordance with an aspect of this embodiment of the invention, a communications system is disclosed comprising an interface to receive signals to establish a call connection with a caller and a processor coupled to the interface. The processor is programmed to insert an identifier of the one of the plurality of users into an event record for the call based, at least in part, on a voiceprint of the user received in the call.

In accordance with another embodiment of the invention, a method of operating a communications system is disclosed comprising identifying an account associated with a user of the system based, at least in part, on a voiceprint of the user and a first voiceprint sample of the user, stored by the system. The method further comprises collecting a voiceprint of the user while the user is requesting a service from the system and processing the voiceprint for storage as a second voiceprint sample of the user. The voiceprint may be collected by tapping into the call, such as by conferencing into the call, for example. The voiceprint may be processed for storage by combining the voiceprint with prior voiceprints to derive the second voiceprint sample, for example.

In accordance with an aspect of this embodiment of the invention, a communications system is disclosed comprising an interface to receive a call and a processor coupled to the interface. The processor is programmed to identify an account associated with a user of the system based, at least in part, on a voiceprint of the user and a first voiceprint sample or model of the user, stored by the system. The processor is further programmed to collect a voiceprint of the user while the user is requesting a service from the system and process the voiceprint for storage as a second voiceprint sample of the user.

In accordance with another embodiment of the invention, a method of operating a communications system is disclosed comprising, setting a voiceprint comparison threshold to identify a user based, at least in part, on a phone type of the phone used to call the system. The phone type may be determined based, at least in part, on at least one of user registration information, local exchange routing guide information, and an operating company associated with the phone, for example. A voiceprint of a user may be compared to a voiceprint sample and the result may be compared the set threshold. The identity of a caller as a particular user associated with a respective account of the system, may thereby be verified.

In accordance with an aspect of this embodiment of the invention, a communications system is disclosed comprising an interface to receive a call and a processor coupled to the interface. The processor is programmed to set a voiceprint comparison threshold to identify a caller based, at least in part, on a phone type of a phone used to call the system.

In accordance with another embodiment of the invention, a method of operating a communications system is disclosed comprising monitoring changes in at least one of phone numbers and addresses of accounts of users of the system and flagging accounts wherein at least one of the phone number and address has changed. The method may further comprise raising a voiceprint verification threshold if the account is flagged.

In accordance with an aspect of this embodiment of the invention, a communications system is disclosed comprising an interface to receive a call and a processor coupled to the interface. The processor is programmed to monitor changes in at least one of phone numbers and addresses of accounts of users of the system and flag accounts wherein the at least one of the phone number and address has changed. The processor may be further programmed to identify an account associated with the phone and raise a voiceprint comparison threshold if the account is flagged.

In accordance with another embodiment of the invention, a method of operating an information assistance service system is disclosed comprising registering a party as a user of the system by collecting text independent verbal information from the caller, to set up an account. The method further comprises recording the text independent verbal information and generating a voiceprint sample from the verbal information. When a call is received from the user seeking information assistance, the method identifies the account of the user based, at least in part, on signals received in establishing the call with the system. A voiceprint of the user is received and the identity of the user is verified based, at least in part, on the voiceprint of the user. Information assistance is then provided. The method may further comprise registering a second party as a second user of the system, in association with the account, by collecting text independent verbal information from the second party, recording the text independent verbal information and generating a voiceprint sample from the verbal information. In accordance with another aspect of this embodiment, an information assistance service system is disclosed, as well.

The terms “users” and “subscribers” are used interchangeably in the description and claims to refer to parties registered to use the system. The terms may include a party who is responsible for payment for use of the system pursuant to an account with the system and other parties the responsible party designates as being authorized to use the system under the responsible party's account. For example, the responsible party may authorize family members to use the system under the account. A business may authorize particular employees to use the system under the account.

These inventions may be used separately or together in a communications system, such as an information assistance service system.

### BRIEF DESCRIPTION OF THE DRAWINGS

Further objects, features and advantages of the invention will become apparent from the following detailed description taken in conjunction with the accompanying drawing showing an illustrative embodiment of the invention, in which:

FIG. 1 is an example of a communications system, here an information assistance service system, including information assistance service centers (“LASCs”), an information hub and a billing platform, that may implement aspects of the present invention;

FIG. 2 is an example of an IASC of FIG. 1, in more detail;

FIG. 3 is an example of a profile gateway of FIG. 2, in more detail;

FIG. 4 is an example of a voiceprint gateway of FIG. 2, in more detail;

FIG. 5 is a flowchart of an example of a method of obtaining a voiceprint sample in accordance with one embodiment of the present invention;

FIG. 6 is a flowchart of an example of a method of obtaining additional verbal utterances for use in deriving a voiceprint sample in accordance with another embodiment of the present invention;

FIG. 7a is a flowchart of an example of a method of adjusting a threshold for use in verifying a voiceprint in accordance with an embodiment of the present invention;

FIG. 7b is a flowchart of an example of a method of using a different voiceprint sample, dependent on a phone used to call the system;

FIG. 8 is a flowchart of a method of adjusting a threshold in accordance with another embodiment of the present invention, when there is reason to believe that a subscriber's phone number may have changed;

FIG. 9 is a flowchart of an example of a method of setting message limits for each party of a multi-party account in accordance with another embodiment of the present invention;

FIG. 10 is a flowchart of a method of allocating calls to particular parties of a multi-party account, in accordance with another embodiment of the invention;

FIG. 11 is an example of a call detail record including an identifier of a particular party of a multi-party account, for use in the method of FIG. 10; and

FIG. 12 is an example of an alternative IASP for use in the system of FIG. 1.

### DETAILED DESCRIPTION

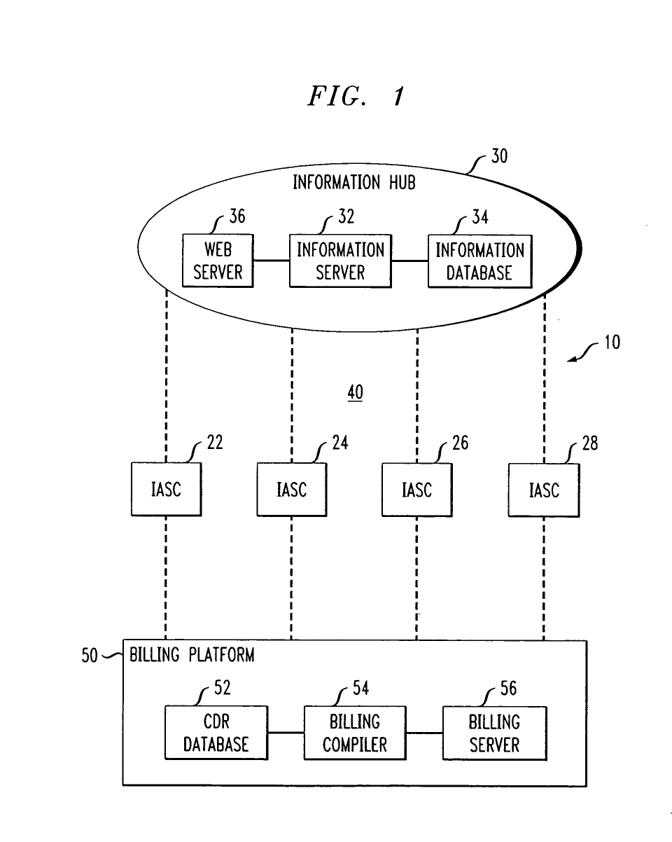

FIG. 1 illustrates an example of a communications system 10 for implementing the present inventions. In this example, the communications system 10 is an information assistance service system. The information assistance service system 10 includes a plurality of operators dispersed throughout a wide coverage area in information assistance service centers (“IASCs”) 22 through 28. IASCs 22 through 28 are coupled to each other and to one or more information hubs 30 through a network 40. The network may be a wide area network (“WAN”) 40 covering an extensive area, for example. WAN 40 can be an Internet-based network, such as the World Wide Web, or a private intranet based network. Each of IASCs 22 through 28 may cover one or more regional coverage areas. Information assistance service system 10 may be accessed directly by a user on a wireline phone, wireless phone, and other such communications devices through which a customer may communicate with service 10 by voice.

Information hub 30 may include one or more processors, such as information server 32, which is accessible by the operators in the system 10, and one or more memory devices, such as information database 34, in which identifying information about each subscriber is stored and maintained. The user information may be in the form of individual subscriber folders for each current subscriber account. Each subscriber account may include one or more individual subscribers. For example, a single account may include multiple members of a family or multiple employees of a business. Folders may be maintained for former subscriber accounts, as well.

Each folder may be associated with one or more communications identifications of the respective subscriber's communications devices that the subscriber has registered with system 10 as part of the account. For example, the communications identification may be a phone number of a subscriber's wireline or wireless phone. The communications identification may be an Automatic Number Identifier (“ANI”), for example. The presence or absence of a subscriber folder corresponding to a phone number or other such identifying data may be used to indicate whether a caller is a subscriber to the system or not.

The folder may include a user profile, as described in co-pending application Ser. No. 09/865,230, filed on May 25, 2002 (“the '230 application”), assigned to the assignee of the present invention and incorporated by reference herein. The user profile may contain preferences of the subscriber related to subscribed services, such as preferred ways of receiving the services, and methods of delivering information to the subscriber. Information server 32 may include clock and calendar functions. The user profile may also contain a voiceprint sample of the one or more subscribers associated with the account. The voiceprint sample may be compared to a voiceprint received from a caller to verify the identity of the caller, enabling greater personalization of services, as described further, below.

The personal preferences in the user profile may be specified by a subscriber during registration with system 10 via a phone call, for example, in response to registration questions posed by an operator or a voice response unit (“VRU”), for example. Personal preferences may also be entered and changed via a web page. A subscriber will typically also register the phone number of each phone that may be used to call system 10, and identify the type of phone as a wireline or wireless phone. A phone that is used as a speakerphone may also be identifies as such.

One or more voiceprints may be obtained during the registration process and subsequent calls between a subscriber and system 10 to derive a voiceprint sample, in accordance with certain embodiments of the invention, as discussed further below. If there are multiple parties to an account, each party may provide a voiceprint during registration by speaking on the phone in turn, or at a later date.

Subscriber folders and other such information may also be stored locally at one or more of the IASCs 22 through 28, as described in the '230 application. Local storage may speed access to the information by a respective IASC 22 through 28. The folders and information at different IASCs may be synchronized. Synchronized databases provide necessary backup as well as support to roaming mobile device users.

Web server 36 may also be provided in information hub 30, coupled to information server 32 and/or other servers. Subscriber account information, such as billing information, may be stored in web server 36. The system's web site may also be provided by web server 36 or by another server connected to the Internet. Web server 36 may be coupled to system 10 at other locations, as well.

IASCs 22 through 28 may also be coupled to billing platform 50 via WAN 40 or other such network. Billing platform 50 generates billing records, which may be bills or precursors to bills, from event records, such as call detail records (“CDRs”), generated by IASCs 22 through 28 to document the events occurring during a call. An “event” may be any activity at the call center related to handling of the call. Each “event” during the course of a call may cause generation of a CDR by a component of the call center involved in that event. For example, upon receipt of a directory assistance call, a carrier switch may generate a CDR and direct the call to one of the IASCs 22 through 28. Other examples of events that may cause generation of a CDR include queuing a call while waiting for an operator to become available, connecting the call to an available operator, conducting a search of a database for directory assistance or other services, activating a voice response unit (VRU), connection to a destination number, etc. The generation of CDRs for such events is described in copending application Ser. No. 09/777,061, filed on Feb. 5, 2001, which is assigned to the assignee of the present invention and is incorporated by reference, herein. Billing platform 50 may be part of information assistance service system 10 or part of a network carrier. It may also be a third party contracted to compile information for bills, contracted by system 10.

The CDR or CDRs generated during a communication contain the communication related information necessary to compute a bill for the communication, such as call duration, toll connection, information assistance service, and the type and/or class of information service provided, to the extent that charges vary depending upon the type of information service provided. CDRs are sent to billing platform 50, which compiles the CDRs for each call and for calls for each customer.

Billing platform 50 may comprise call detail record (“CDR”) database 52, billing compiler 54 and billing server 56. CDR database 52 collects and stores CDRs generated by IASCs 22 through 28. Billing compiler 54 is a processor or computer that compiles CDRs related to the same call and to the same customer. CDRs related to the same call may be identified by a common identification number assigned to each CDR by an IASC 22 through 28 handling a particular communication, as described below. CDRs related to the same subscriber may be identified by the ANI of the phone registered with the subscriber's account, for example, and incorporated in the CDR. A customer may have multiple phones with respective ANIs and/or other communications identifications registered with the account. Each ANI may cause generation of a separate bill or the charges for each phone may be compiled into a single bill. While a single CDR database 32, billing compiler 34 and CDR server 36 are shown, it is understood that multiple databases, compilers and servers may be used.

Billing server 56 computes appropriate charges for each call based on stored rate information and the compiled CDRs, and generates a billing record. The billing record may be a customer bill, or a precursor to a customer's bill. If billing platform 50 is part of a third party, a precursor to a bill is typically generated by billing server 56. The precursor may be provided to information service system 10, such as to web server 36, for final formatting and presentation to a customer, by mail, e-mail or through the website. An electronic bill may be generated instead of or along with the printed bill, for being e-mailed or otherwise sent electronically to the customer. Billing server 56 may also format and generate a bill and convey it to a customer by any of the methods described above. Billing server 56 also stores the generated bills and the underlying CDRs in appropriate memory (not shown) for later reference.

While information assistance service system 10 in this example includes a plurality of IASCs 22 through 28, the invention may be implemented in a system including a single IASC coupled to an information hub.

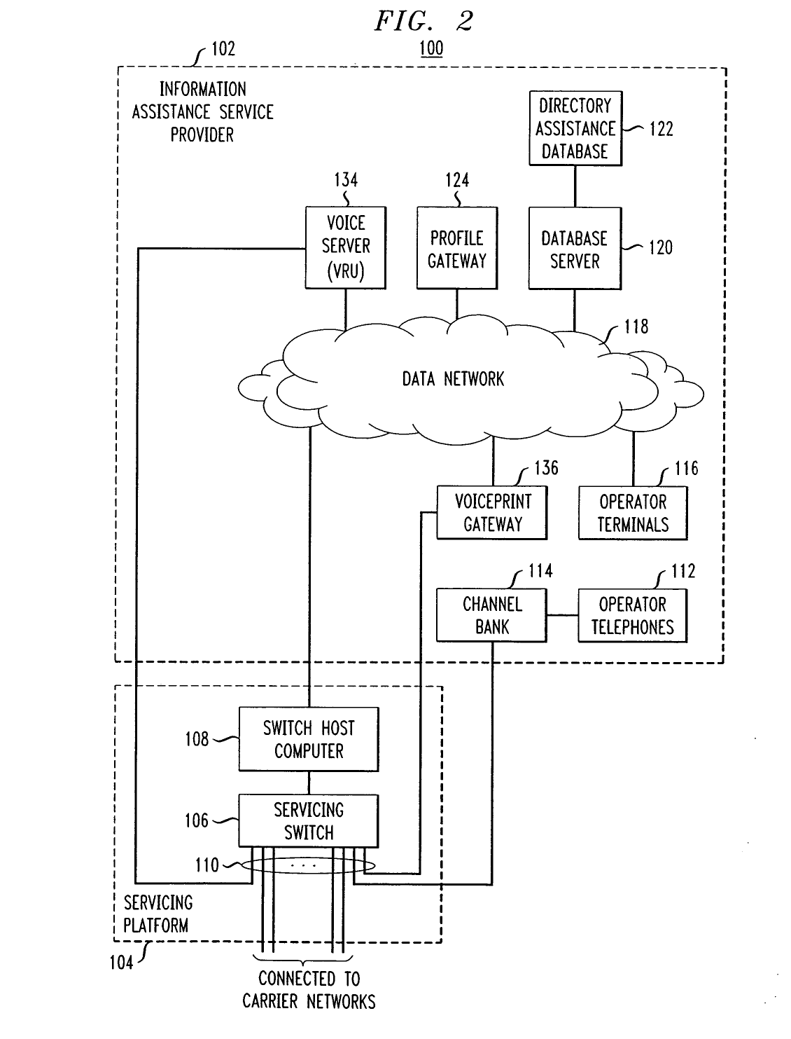

FIG. 2 illustrates an example of an IASC 100, which generically represents one of aforementioned IASCs 22 through 28, in more detail. IASC 100 comprises information assistance service provider (“IASP”) 102 and servicing platform 104. Servicing platform 104 may be part of IASP 102 or separate from it. Servicing platform 104 may be located in the same geographic area or in a different geographic area than the associated IASP 102.

Servicing platform 104 includes an interface, such as a servicing switch 106, and a switch host computer 108. Switch 106 is a conventional switch connected via one or more external T1 links 110, including digital T1 links, to one or more carrier networks (not shown). T1 links 110 may be voice, data or video connections through which incoming and outgoing voice, data, and/or video communications can be made. Outgoing communications may be placed over the same or different carrier networks than the carrier network on which the incoming communication was received. Switch 106 includes digital signal processing (DSP) circuitry. Thus, switch 106 can be programmed and reprogrammed to function as, among other things, call progress analyzers (CPAs), call progress generators (CPGs), multi-frequency (MF) tone generators/detectors, dual-tone multi-frequency (DTMF) generators/detectors, and/or conferencing units, depending upon the demand placed on IASP 102 and switch 106 for each corresponding function.

Switch host computer 108 may be programmed to control the operation of servicing switch 106, as well as the operation of the other components of IASP 102 described below. Servicing switch 106 may also be programmed to control some or all operations of the switch, instead of or in addition to the control provided by switch host computer 108. Switch host computer 108 and servicing switch 106 may each be private branch exchange (“PBX”) components. In FIG. 12, in contrast, IASP 900 is shown without a PBX switch and host computer.

The one or more operators in IASP 102 are equipped with operator telephones 112, which are coupled to servicing switch 106 via channel bank 114 and a T1 link 110. The one or more operators are also equipped with respective terminals 116. Each terminal 116 includes a video display unit and a keyboard with associated dialing pad (not shown). Operator terminals 116 are connected over data network 118 to one or more database servers 120 (although only one is shown here). The database server 120 is coupled to one or more directory assistance databases 122.

Operators at operator terminals 116 may access database server 110 to obtain requested information, such as a user's desired party and the appropriate destination telephone number of the party, by conducting searches for the requested information. Other information assistance or specialized communications services, such as restaurant recommendations, movie listings, events, special offers, etc., may also be provided by searching database server 110.

Data network 118 includes a local area network (LAN) supplemented by a number of point-to-point data links, for example. Through data network 118 and routers (not shown), components of IASP 102 may also be connected to the Internet.

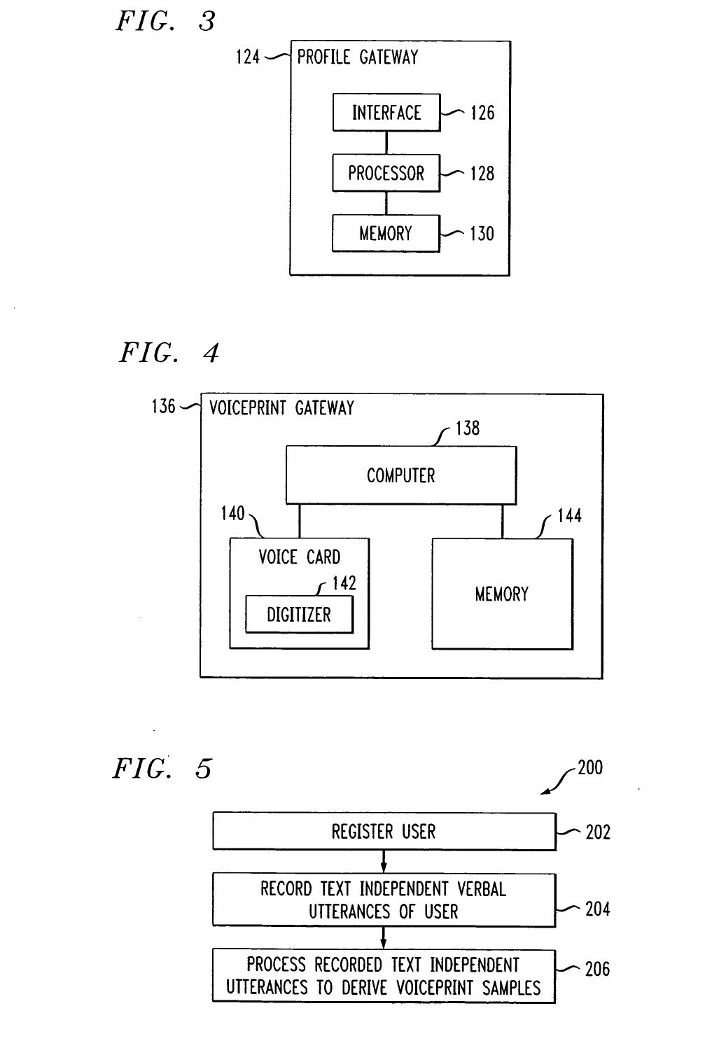

IASP 102 also includes profile gateway 124 coupled to data network 118. Profile gateway 124 contacts information hub 30 to request information about a subscriber, such as a subscriber profile. Profile gateway 124 may comprise interface 126, processor 128 and memory 130, as shown in FIG. 3. Memory 130 here generically includes disks, caches and volatile and non-volatile memory. Subscriber profiles and profile gateway are discussed in more detail in copending application Ser. No. 09/865,230, filed on May 25, 2002, which is assigned to the assignee of the present invention and is incorporated by reference, herein.

Voice server 134, which may be a voice response unit (“VRU”), for example, is used to play the constantly repeated parts of an operator's speech, such as, the various greetings and signoffs (or closings). Voice server 134 may also have voice recognition capability, to interpret verbal statements made by a customer. For example, instead of connecting a call to an operator, switch host computer 108 may connect the call to voice server 134, which may request that the customer recite the name of a party for example customer desires directory assistance, as described further below. Voice server 134 is connected via data network 108 to switch host computer 108 and via one or more T1 spans to switch 106. Voice server 134 may comprise a general purpose computer and one or more voice cards for voice recognition, voice recording and playback, and call progress analysis, for example. If more than one voice server is provided, each one is connected to servicing switch 106 by a separate T1 link.

At appropriate stages in a call progression, switch host computer 108 initiates a voice path connection between voice server 134 and switch 106 so that the caller, or the caller and the operator, are able to hear whatever pre-recorded speech is played on that connection by voice server 134. Switch host computer 108 then instructs voice server 134, via data network 118, what type of message to play, and passes data parameters that enable voice server 134 to locate the message appropriate to the call.

Voiceprint gateway 136 is provided to receive, record and digitize a voiceprint received from a caller. Voiceprints for use in developing a voiceprint sample or model for comparison to later received voiceprints, are also received and processed initially by voiceprint gateway 136. Processing of voiceprints into voiceprint samples is discussed further, below. Voiceprint gateway 136 may be structurally similar to voice server 134 and their functions may be combined. Voice server 134 may be coupled to servicing switch 106 through voiceprint gateway 136, instead of being directly connected to it, as shown in FIG. 2. Voiceprint gateway 136 may play instructions to a caller, as well, such as asking the caller to repeat a passphrase/password, for example, so that a voiceprint may be collected. As shown in FIG. 4, voiceprint gateway 136 may comprise computer 138, such as a general purpose computer. One or more voice cards 140 and memory 144 are coupled to computer 138. Voice card 140 may include digitizer 142. As above, memory 144 generically includes disks, caches and volatile and non-volatile memory. Voiceprint gateway 136 is coupled to servicing switch 106 via one or more T1 links 110 and to data network 118. Voiceprint gateway 136 may be a LINUX server running suitable voice recognition or speaker identification software. For example, the voiceprint gateway 136 may run SpeechSecure™, available from SpeechWorks International, Inc., Boston Mass. Exemplary patents related to speech verification include U.S. Pat. No. 6,519,561, U.S. Pat. No. 6,480,825, U.S. Pat. No. 6,038,528, U.S. Pat. No. 5,862,519, U.S. Pat. No. 5,839,103, U.S. Pat. No. 5,634,087, and U.S. Pat. No. 5,634,087, which are incorporated by reference, herein. Suitable software may also be obtained from Nuance Communications, Inc., Menlo Park, Calif., for example.

To access IASC 100 of information assistance service system 10, customers of a particular telephone carrier or company may dial, speak or otherwise communicate the access digits, access codes or retail numbers established for information assistance by that carrier to access information assistance service system 10. For example, the predetermined access digits may be “411,” “*555,” “555-1212,” “1-800-555-1212,” “00,” or other designated access numbers. Upon receiving such access digits from a customer's communications device, the participating telephone carrier's switching system routes the call to an IASC 100 of information assistance service system 10 (via a T1 link 110), where it appears as an incoming call. Customers and other users of information assistance service system 10 may also call the system directly, in which case the call is also received by servicing switch 106 along one of the T1 links 110.

To connect a call to an IASC 100, a carrier network switch (not shown) of a participating carrier sends call setup signals containing data concerning the call, such as an ANI identifying the originating wireline or wireless phone, a dialed number identification service (DNIS) string identifying the dialed telephone number or other such communications number, the area of the call's originating site, and/or a customer identification number assigned by the carrier, to servicing switch 106. The received set-up signals are monitored and processed by switch host computer 108, which assigns a call sequence number to the call, to uniquely identify the call within the information assistance system 100. A CDR is created for each call by switch 106, based on this information.

System 10 uses several criteria to identify a caller as a subscriber to the system before providing service to the subscriber. Preferably, at least two criteria must be met to verify the identity of a caller as a subscriber. In one example, the first criteria is a phone number or other such identifier of a phone registered with system 10. An identifier in the call set-up signals, such as the ANI, is identified and if the phone is registered with an account with the system, the phone and the associated account is identified. The DNIS may also be used under certain circumstances, as discussed above. A caller may also inform an operator of system 10 of a phone number of a registered phone, verbally. For example, if a caller is not calling from a registered phone, an operator or voice server 134 may request that the caller provide a number of a registered phone. The caller is thereby preliminarily identified as a particular authorized user (if there is only one user associated with the account), or as one of a limited number of authorized users associated with the account.

In this example, the second criteria is the voiceprint of the caller. To verify that the caller is the preliminarily identified user or to identify the caller as a particular one of several authorized users, a voiceprint of the caller is compared with a stored voiceprint sample or samples of authorized users of the account to determine if there is an acceptable match.

In this example, if a voiceprint sample is not available or if voiceprint analysis is not conclusive, a third criteria may be other identifying information, such as a PIN, the user's mother's maiden name, etc. Preferably, either the first and second or the first and third criteria are used to verify identity. It is preferred not to use the second and third criteria together to verify identity. This verification process will now be described in more detail.

To preliminarily identify the caller as a subscriber, switch host computer 106 may extract the ANI from the call setup signals and transmit the ANI to components of IASC 100, including profile gateway 124, through data network 118. Interface 126 of profile gateway 124 may receive the ANI and convey the ANI to processor 128. Processor 128 then requests information server 32 of information hub 30 (see FIG. 1) for a subscriber folder associated with the ANI or other such identifier in the call set up signals, via WAN 40. Information server 32 then searches information database 20 for such a subscriber folder. If a folder is found, it is sent to profile gateway 124, via WAN 40. The folder may be stored in memory 130.

If there is only one subscriber associated with the subscriber folder (and associated account), then system 10 preliminarily identifies the caller as that subscriber. If there are multiple parties associated with the folder (account), then system 10 has preliminarily identified the caller as one of those multiple parties.

The call may be directed to an operator device, such as operator telephone 112 and operator terminal 116 of an available operator, by switch 106 under the control of switch host computer 108. Information in the subscriber folder, such as the subscriber's name and preferences, is made available to an operator from profile gateway 124 via their respective terminal 116.

Automatic call distribution (ACD) logic, which may reside in switch host computer 108 or elsewhere in system 100, may be used to queue (if necessary) and distribute calls to available operators at operator devices in the order in which they are received, to evenly distribute the call traffic among the operators. Other distribution logic schemes may be used instead, such as skills-based routing or a priority scheme for preferred callers.

To confirm the identity of the caller as the preliminarily identified subscriber, or to identify the caller as one of the multiple parties to the account, the voiceprint gateway 136, voice server 124 or the operator may ask the subscriber to state their passphrase or password to obtain a voiceprint of the caller. Voiceprint gateway 136, which may be conferenced into the call, receives and digitizes the passphrase or password to form the voiceprint. The voiceprint is encapsulated within a Voice Extensible Markup Language (“Voice XML”) file and sent to information server 32 with instructions to compare the voiceprint to the voiceprint sample or model stored in (or associated with) the subscriber folder in information database 34 identified through the ANI (and already provided to profile gateway 124). The digitized voiceprint is compared to the voiceprint sample to yield a statistical measure of the correspondence between the two. The measure may be a confidence score, for example, indicative of the degree of correspondence between the received voiceprint and the stored voiceprint sample. The confidence score may be compared to a threshold to determine if the degree of correspondence is sufficient to conclude that the voiceprint and the voiceprint sample are from the same party, with an acceptable degree of certainty. If a score is below the threshold, the identity of the caller as a particular subscriber is not confirmed. The operator may then ask the caller for other information to confirm their identity, such as a PIN, name, address, mother's maiden name, etc. Voiceprint gateway 136 or voice server 134 may also compare the voiceprint to the voiceprint sample and compare the resulting confidence score to the threshold.

An upper and a lower threshold may be provided defining three ranges. If the confidence score is greater than or equal to the upper threshold, the identity of the caller as a particular subscriber is confirmed. If the confidence score is below the lower threshold, the test is failed and service will not be provided, unless the caller provides additional information to satisfy the operator that caller is who they purport to be. For example, the caller could provide a name, PIN and mother's maiden name. If the confidence score is greater than or equal to the lower threshold but less than the upper threshold, the results are ambiguous and the operator, voice server 134 or voiceprint gateway 136 may ask the caller to repeat the passphrase/password or provide other information, such as a PIN. On a scale of 0.0 through 1,000.0, the upper threshold may be 600 and the lower threshold 350, for example.

A subscriber may fail the voiceprint test because the registered phone number of the subscriber has been assigned to another party. The subscriber may have moved, for example, and not updated system 10. Alternatively, the caller may be a subscriber using a new phone, who may not have updated system 10. The operator may then update the subscriber's account. If the caller does not have a subscription, the operator may offer to register the caller with system 10.

If there is only one subscriber to an account, then the voiceprint received from the caller need only be compared to the one voiceprint sample of that subscriber. In this case, the voiceprint verifies the identity of the subscriber, who has been preliminarily identified based on the ANI or other such identifier of the subscriber's phone.

If there are multiple parties to the account, such as family members or employees of a business, there may be multiple voiceprint samples in or associated with the account. The received voiceprint may be compared to each voiceprint sample and the identity of the caller may be determined based on the voiceprint sample with the highest confidence score equal to or above the threshold. Multiple thresholds may be provided, as discussed above. In this way, a caller may be identified without requiring input of a PIN or other such information.

If a subscriber is calling from a public phone or another party's phone who is not a subscriber to system 10, the ANI of the phone will not be correlated with a subscriber account. In that case, the operator, or voice server 134 or voiceprint gateway 136 may then ask for identifying information, such as the caller's name or phone number of the phone registered with the system. The caller's voiceprint may then be used to verify the identity of the caller. Further information may be requested to verify the identity of the caller, such as the user's PIN, password, mother's maiden name, etc. The voiceprint may then be used, if desired, to provide further verification that the caller is the subscriber corresponding to the PIN, etc.

If the caller is using another subscriber's phone, then the system will preliminarily identify the caller as that other subscriber. The voiceprint of the caller should not, however, sufficiently correspond to the voiceprint of the other subscriber and the identity of the caller as the subscriber will not be verified. Again, the operator, voice server 134 or voiceprint gateway 136 will then ask the caller for the caller's name and/or phone number of a registered phone. The voiceprint and/or other identifying information may then be used to verify the identity of the caller, as discussed above.

Voiceprints work best in identifying one out of a limited number of parties. In most cases, the ANI will narrow the class of probable callers to the one or limited number of parties associated with an account. The voiceprint of the caller may then be used to readily and quickly verify the identity of the one party or determine which one of a limited number of parties is the caller. If there are too many parties associated with the account to match a voiceprint in a reasonable amount of time, it may still be necessary for an operator or voice server 132 to intervene and request additional information. A voiceprint may be compared to up to about 25 voiceprint samples in a reasonable amount of time with acceptable accuracy for a typical information assistance service system, for example.

After verification of the identity of the subscriber, the operator may address the subscriber by the name found in the subscriber folder The subscriber may then request information assistance, such as the phone number and/or address, of a party and/or concierge services. Concierge services include the name, address, and phone number of parties providing particular requested goods and services, including food and entertainment services. The operator may enter the name of the requested party into a field of a graphical user interface (“GUI”), which may be a form template appearing on the display of the operator's terminal 116, through a keyboard or other such input device. The operator submits the requested party's name to database server 120 via data network 118 by clicking on a button or tab on the screen or depressing a key on the keyboard. Database server 120 conducts a search of directory assistance database 122 for the requested party.

If a phone number, address or other such communications identification corresponding to the requested party's name is found, the number may be sent to the requesting operator terminal 116 by database server 120. The retrieved number may be displayed on the operator's monitor. The customer may then be verbally informed of the number by the operator. Alternatively, the number may be provided to voice server 134 via switch host computer 108. Voice server 134 may then generate a message reciting the number.

The information assistance call may then be terminated or the customer may be given the option of being connected with the communications number (i.e. telephone number) of the requested party, as is known in the art. The option may be presented by the operator or by voice server 134. The customer may accept the option by a verbal indication to the operator or voice server 134 or by entry of data through the customer's phone. If the call is connected to the requested party, servicing switch 106 may send call setup signals for the call, including the requested party's number as a DNIS, to a carrier switch for connection to the requested party. Alternatively, system 10 may connect the call to the requested party via servicing switch 106. The information assistance call is then completed. The connection between the customer and the IASP 10 may be terminated or it may be maintained in order to provide additional information assistance via the well-known StarBack® feature.

Instead of connecting the call to an operator at an operator device, switch host computer 108 may connect the call to voice server 134 to request verbal input of a requested party's name or concierge request and/or to present other options, as is known in the art. If voice server 134 can identify the request, the name is conveyed to data server 120 via data network 118, to conduct a search, as described above. If voice server 134 cannot identify the request, the call is connected to an operator device by switch host computer 108 for handling by an operator, as described above.

As mentioned above, verbal utterances of a subscriber to system 10 may be collected during phone registration of the subscriber (or at a later time) to derive voiceprint samples. Voiceprint gateway 136 may be conferenced into the call, and request the new subscriber to repeat a passphrase or password several times, such as three times, for example. The passphrase or password is recorded and digitized by voiceprint gateway 136. The digitized voiceprints are encapsulated in a Voice XML file and sent to information server 32 with instructions that the voiceprints are to be processed to form voiceprint samples. Information server 32, which also runs SpeechWorks(™) or other appropriate software, creates a mathematical representation of the voiceprints to form a voiceprint model or sample, and stores the voiceprint sample. Preferably, the voiceprint sample is stored in information database 34 as part of the subscriber profile in a folder for the new subscriber. Voiceprint gateway 136 or voice server 134 may process the voiceprints into voiceprint samples instead of or along with information server 34, as well.

If multiple parties are registering under the same account, verbal utterances of each registered party may be collected and processed in turn. Each registered party may also establish other preferences, such as how they wish to be addressed by the operator and what language they prefer when dealing with system 10, for example. The voiceprint sample identifying information and preferences of each registered party to the account are preferably associated with separate subscriber profiles or sub-profiles within the subscriber folder associated with the account. The subscriber folder, and hence each of the profiles or sub-profiles, is associated with the ANI of the phones registered with the account. The information may be organized in other ways, as well.

Asking a subscriber to repeat a particular passphrase or password multiple times, may make the subscriber nervous and speak unnaturally. It may also increase the time required to register the subscriber, which may be annoying. In accordance with an embodiment of the invention, voiceprint samples are derived from verbal utterances during registration of the subscriber. For example, during registration of a new subscriber, the new subscriber is typically asked for their name, address, phone numbers of wireline or wireless phones or communications numbers of other communications devices they may use, a password, a PIN, credit card information to pay for the subscription, etc. The new subscriber verbally provides this information in response to queries by an operator, account representative or voice server 134.

A voiceprint sample may be derived based on the verbal utterances of the subscriber during this registration process. SpeechSecure™, for example, may derive a voiceprint sample in a text independent mode, where a speaker does not follow a predetermined script (such as repeating a passphrase or password). The subscriber's verbal utterances may be readily distinguished from that of the operator because the operator's voice and the subscriber's voice by changing the state of the connection between the operator and the subscriber. For example, the connection may be changed from a two way to a one way conference connection, for example,

FIG. 5 is an example of a method 200 in accordance with this embodiment of the present invention, wherein a new subscriber to information assistance service system 10 is registered with the system, in Step 202. Text independent verbal utterances are recorded in Step 204, as the subscriber is speaking to the operator and providing registration information. The recorded utterances are processed into a voiceprint sample, in Step 206. For example, text independent processing may be used to derive the voiceprint sample.

Generally, the greater the number of voiceprints obtained, the more accurate the resulting voiceprint sample or samples, and thus the more accurate the voice verification. As mentioned above, however, requesting a customer to repeat words or phrases too many times during registration may annoy the customer and may result in an unnatural speaking voice. In accordance with another embodiment of the invention, additional voiceprints are collected to “fine tune” an existing voiceprint sample, by conferencing or otherwise tapping voiceprint gateway 136 into conversations between subscribers and operators of system 10, to collect additional verbal utterances in a text independent mode. Alternatively, the call may be connected to voiceprint gateway 136 and the operator may be conferenced in. The operator may also be in listen-only mode on the same channel. The operator's voice and the caller's voice may thereby be readily distinguished.

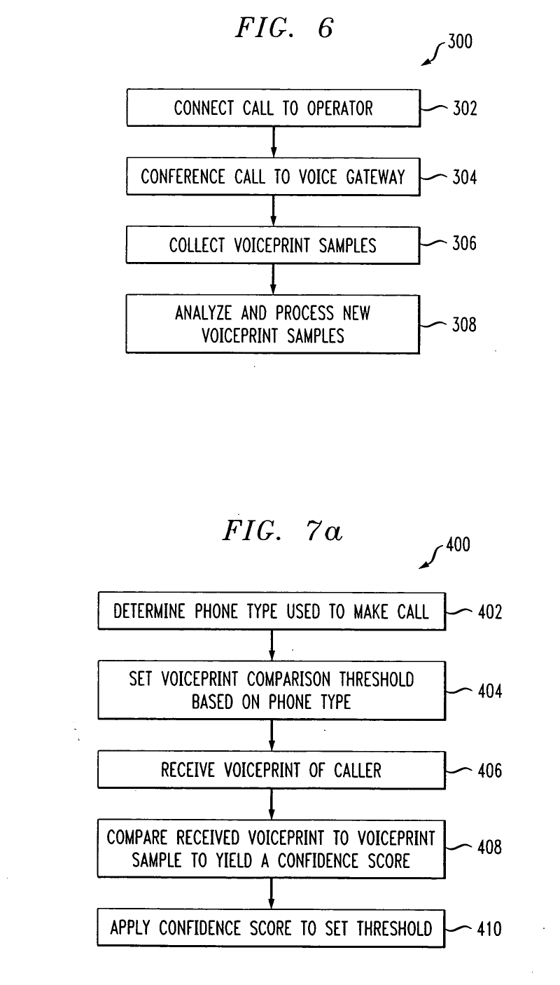

FIG. 6 is an example of a method 300 in accordance with this embodiment of the invention. A call is connected to an operator in Step 302. The call could be connected to voice server 134, instead. Voiceprint gateway 136 is conferenced into the call, in Step 304. Switch host computer 108 may conference voice gateway 134 into the call, for example.

Voiceprint samples are collected in Step 306. Voiceprint gateway 134 may record and digitize voiceprints of the subscriber and send them to information server 32, as discussed above, for example.

The digitized voiceprints are analyzed and processed, in Step 308. Information server 32 may first determine whether the voiceprint is acceptable for use as a sample. For example, voiceprints including too much noise or not enough energy may be rejected. Information server 32 may average acceptable voiceprints with the existing voiceprint sample, for example. Alternatively, a new voiceprint sample may be derived from the new voiceprints, in combination with the original voiceprints collected during registration (which may have been saved). The new voiceprints may replace voiceprints of lesser quality in derivation of a new voiceprint sample, as well. The new voiceprints may be weighted based on environmental or other such factors. For example, a voiceprint that is acceptable but contains more than a predetermined amount of noise may be weighted to have a lower contribution to the new voiceprint sample than a voiceprint with less noise. Such processing may be performed by voiceprint gateway 136 instead of or along with information server 32.

As discussed above, voiceprints of authentic callers may not sufficiently match their voiceprint sample, due to noise and other factors associated with the phone used to call system 10. In accordance with another embodiment of the invention, a voiceprint comparison threshold is adjusted based on the source of the call. For example, a threshold set for a wireline phone, which typically has less noise and broader bandwidth than a wireless phone, may be lowered if a call is from a wireless phone or speakerphone, to allow for the increased noise typically present.

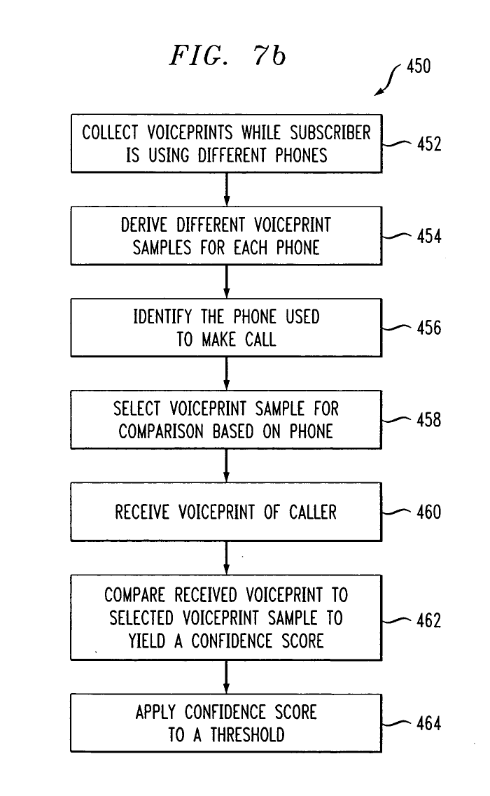

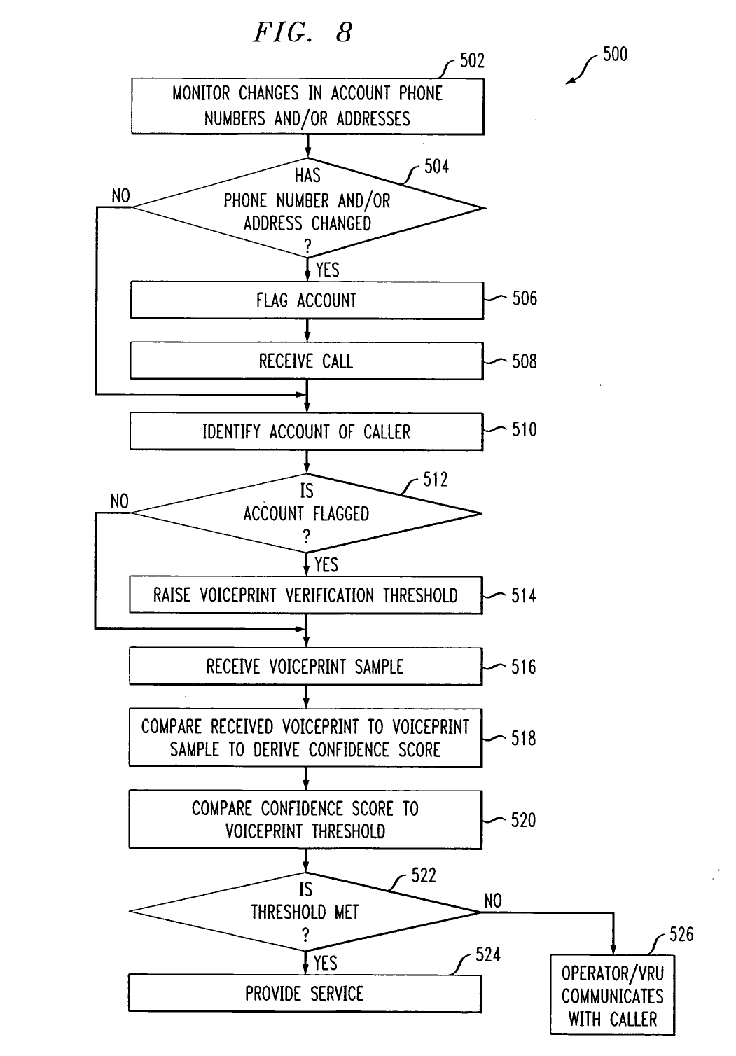

FIG. 7a is an example of a method 400 in accordance with this embodiment of the invention. A phone type used to make a call to system 10 is determined, in Step 402. Phone type may be determined in a variety of ways. For example, during registration, a new subscriber may identify the type of phone associated with each phone number registered with system 10, as a wireline, wireless or speakerphone, for example. The phone type may be stored in a table associated with the phone number. The table may be part of the subscriber profile and/or may be part of another file. Information server 32, profile gateway 124 or switch host computer 108 may determine the phone type based on this information.

The type of phone associated with the ANI/MIN may also be determined by the Telcordia Local Exchange Routing Guide (“LERG”), such as LERG6, based on the first six digits of the ANI. System 10 may also identify the operating company associated with an ANI to determine if the phone is a wireline or wireless phone, also through LERG6.

The threshold is set based, at least in part, on the phone type, in Step 404. For example, if a first threshold is used for wireline phones and it is determined that the phone type is a wireless phone or a speakerphone, the threshold is changed in accordance with this embodiment. Different, lower thresholds may be used for wireless phones and speakerphones, or the same lower threshold may be used. For example, if the default upper threshold is 600, it may be lowered to 550 for a speaker phone and to 500 for a wireless phone. Appropriate thresholds may be determined to decrease the rejection of authentic subscribers to a desired level, based on use of the system, over time, for example. No threshold may be set until the phone type is determined, or the system may have a default threshold that is used unless it is determined that the threshold should be changed based on phone type. The default setting may be the appropriate threshold for either a wireline phone or a wireless phone, depending on the most common phone type among subscribers of system 10. The threshold may then be set to a different level if the phone type of the phone used to make a particular call is different than the phone type of the default setting. Information server 32, voiceprint gateway 136 or switch host computer 108 may set the threshold, for example.

Continuing with the example of method 400, a voiceprint of the caller is received, in Step 406, and compared to a voiceprint sample, in Step 408, to yield a confidence score. The voiceprint confidence score resulting from the comparison between the received voiceprint and the voiceprint sample is then compared to the set threshold, in Step 410, to verify the identity of the caller/subscriber. Multiple thresholds may be used, as discussed above, such as an upper and lower threshold.

To implement Steps 406 through 410, voiceprint gateway 136 may receive, record and digitize the voiceprint and transmit the voiceprint to information server 32. Information server 32 may retrieve the voiceprint sample from information database 34 and compare it to the voiceprint to yield the confidence score.

System 10 may also learn over time that a phone associated with an ANI typically has higher than expected noise. Information server 32 can monitor the acceptable confidence scores based on a particular phone and compare them to confidence scores of other phones of other parties. If the scores are closer to the threshold than is typical, the system may assume that there is more than an average amount of noise on that phone. The threshold may then be lowered an appropriate amount to ensure that an authentic subscriber using that phone will not be rejected.

While the risk of an authentication of an improper party goes up as the threshold is lowered, this risk is mitigated by other identification techniques, such as use of the ANI to make the preliminary identification of the caller. That risk is also offset by the risk of annoying subscribers due to excessive false negative determinations.

The voiceprint comparison threshold may also be set based on the type of service requested. If the requested service is a credit card purchase, for example, a higher degree of certainty is required and the threshold may be raised. Additional indicia of identity may also be requested, such as the caller's PIN.

Instead of changing the threshold based on phone type, as in method 400 of FIG. 7a, in accordance with another embodiment of the invention, different voiceprint samples may be derived from voiceprints collected from different respective registered phones. When a subscriber uses a particular phone, the respective voiceprint sample derived from use of that phone, is used for comparison and generation of a confidence score.

FIG. 7b is an example of method 450 in accordance with this embodiment of the invention. Voiceprints are collected while the subscriber is using different registered phones, for the purpose of deriving different voiceprint samples for each phone. To collect the different voiceprint samples, the subscriber may call system 10 from each registered phone and repeat the passphrase or password while using each phone, for example.

System 10 derives a voiceprint sample from voiceprints received while the subscriber uses each phone, in step 454. System 10 may store each voiceprint in association with an identifier of each phone, such as the ANI of each phone, in the subscriber's folder in information database 34, for example.

When the subscriber calls system 10, the registered phone is identified in step 456, as described above. The voiceprint sample to be used for comparison is selected in step 458, based on the identified phone. For example, the voiceprint sample selected may be the voiceprint sample associated with the identifier of the phone used to call system 10.

The voiceprint of the caller is received in step 460 and compared to the selected voiceprint sample, in step 462, to yield a confidence score. The confidence score is compared to a threshold (or multiple thresholds) to authenticate the caller, in step 464. Step 460 through step 464 have been discussed above in detail.

If a subscriber's phone number has changed or the subscriber has moved, there is a risk that the subscriber's registered phone number has been reassigned. A call from the registered ANI/MIN of the subscriber may not, therefore, be coming from the subscriber. In accordance with another embodiment of the invention, system 10 monitors changes in subscriber's phone numbers and/or addresses, based on information provided by network carriers, for example, and flags accounts of subscribers who have such changes. The threshold for voiceprint verification for calls received from a phone registered with a flagged account may be raised. For example, if a 75% threshold level is acceptable under normal circumstances, a threshold of 90% may be used for flagged accounts. If that threshold is not met, an operator or voice server 134 may request additional identifying information from with caller. If the caller is not the actual subscriber, an account may be established with the caller. The prior account may be put on hold until the subscriber is contacted or the subscriber contacts system 10 to update their profile and provide a new phone number.

FIG. 8 is an example of a method 500 in accordance with this embodiment of the invention. Changes in phone numbers and/or addresses of subscribers of system 10 are monitored to determine if there are any changes, in Steps 502 and 504. Network carriers provide information relating to changes in phone numbers and addresses of their customers to directory assistance and information assistance service systems regularly (daily, for example), so that these services may update their databases. Files of the changes may be compared to files of subscribers of system 10 to identify those subscribers with changed phone numbers and/or addresses. Information server 32 may receive the files of changes from the networks carriers and compare them to files of subscribers.

If a customer's phone number and/or address has changed, their account is flagged, in Step 506. Information server 32 or profile gateway 134 may flag such accounts.

Handling of a call from a caller who may have a flagged account is now described with respect to method 500. A call is received in Step 508 and an account is identified, in Step 510. The account may be identified based on the ANI, as discussed above, for example. The identified account is checked for a flag, in Step 512. Information server 32 may retrieve and check the subscriber folder corresponding to the ANI, for example. Profile gateway 124 and/or switch host computer 108 may also check for the flag. If the account is flagged, the voiceprint threshold is raised, in Step 514. Information server 32 may change the threshold, as discussed above with respect to FIG. 7. If multiple thresholds (upper and lower thresholds, for example) are used, the upper threshold may be changed. A voiceprint of the caller is received, in Step 516. The voiceprint is compared to a voiceprint sample associated with the account to derive a confidence score, in Step 518, as discussed above. The confidence score is compared to the voiceprint threshold, in Step 520, as is also discussed above.

If the threshold is met (Step 522), the call proceeds. Service may be provided, in Step 524. If the threshold is not met, the operator or voice server 134 communicates with the caller to determine if the caller is the expected subscriber associated with the account or another caller, in Step 526. Customer identity may be verified by providing a PIN associated with the account or by providing personal information (mother's maiden name, for example) previously registered with the account, as discussed above. If the caller is not the customer, a subscription may be offered.

In accordance with another embodiment of the invention, voiceprints may be used to individualize subscriber profiles, particularly where the subscriber account covers multiple parties. For example, a family or business may be covered by a single account. Where the customer account is determined based on an ANI or MIN of the one or more wireline or wireless phones that are part of the account, each member of the family or business is typically treated the same. Regardless of who is making the call, the system identifies the one profile of the account. Voiceprints facilitate the access of sub-profiles for each party to the account. The sub-profiles may include individual preferences of that particular customer. For example, each sub-profile may contain the name or nickname by which a respective party wishes to be addressed by the system, and the language in which they prefer to communicate. System 10 may thereby respond to a call from different customers sharing an account, differently. The account may be identified based on the ANI while the sub-profile may be identified based on the voiceprint of the customer.

As discussed above, communications systems, such as information assistance service system 10 and network carriers, may provide promotional and informational messages to customers during a communication with a customer. To avoid saturating a customer with the same message, which may annoy the customer, the message may only be played periodically. If multiple parties are associated with an account, such as multiple family members, messages may not be evenly distributed among the parties to the account.

In accordance with this embodiment of the invention, a voiceprint of a caller to the system is used to identify an individual party to an account, for the purpose of monitoring message limits. In one example, each party to the account may select the frequency that they would like to receive the same message or any message. One party (such as a parent) may select the frequency for other parties (children, for example), as well. In another example, system 10 may determine the frequency. A system may implement any or all of these options. The frequency may be every third or fifth call, for example. Each party or system 10 may also select the total number of times they would like to hear the same message. The number of calls by each subscriber since the last message was played, is monitored for each subscriber, based on the voiceprint. The effectiveness of the messages may be increased and their potential annoyance decreased.

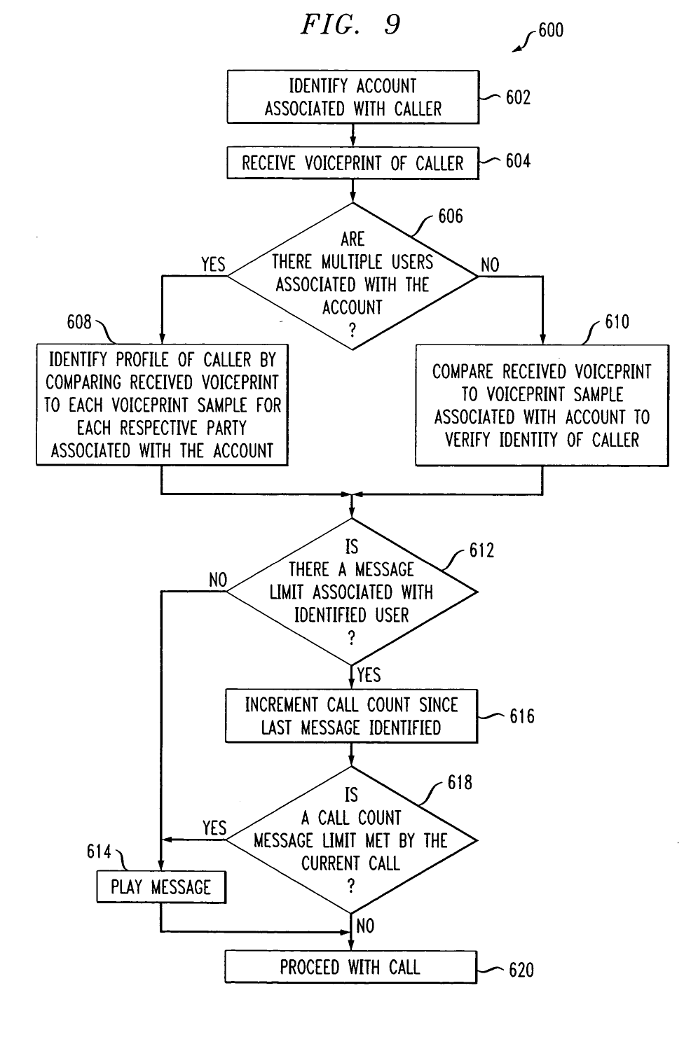

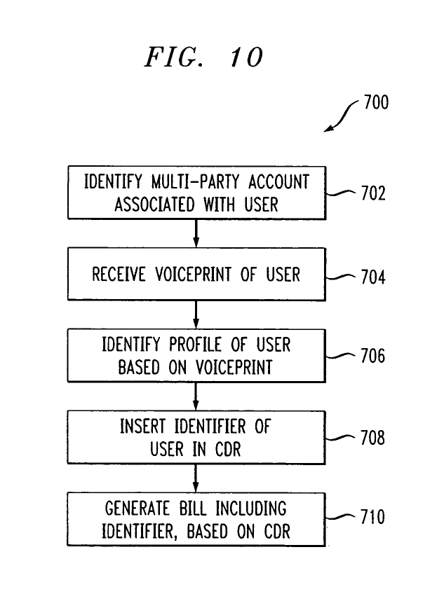

FIG. 9 is an example of a method 600 in accordance with this embodiment of the invention. The account associated with a caller is identified, in Step 602. As discussed above, the account may be identified based on identifiers in the call-setup signals, such as the ANI.

A voiceprint of the caller is received, in Step 604. It is then determined whether there are multiple parties associated with the account, in Step 606. Information server 32 may make this determination by checking the subscriber profile associated with the account, for example.

If there are multiple parties associated with the account, the caller is identified as one of those parties by comparing the received voiceprint to each voiceprint, generating confidence scores and comparing the confidence scores to the threshold, in Step 608. This has been discussed in detail, above. If the confidence score resulting from only one voiceprint sample meets the threshold, the caller is identified as the subscriber associated with that particular voiceprint sample. If the confidence score resulting from several voiceprint samples meets the threshold, the caller is identified as the party associated with the sample yielding the highest confidence score above the threshold. This has been discussed in detail, above. As above, multiple thresholds (an upper and a lower threshold, for example), may be used.

If there are not multiple parties associated with the account, the received voiceprint is compared to the voiceprint sample to verify the caller as the one subscriber associated with the account, in Step 606. This process has been discussed in detail above, as well.

It is then determined whether there are any message limits associated with the account of the identified party, in Step 612, by checking the subscriber profile or sub-profile of the identified subscriber. Message limits may be selected by the subscriber or established by system 10. If there are no message limits, a message may be played in Step 614.

If there is a message limit, a call count since the last message was played is incremented, in Step 616, and it is then determined whether the limit is met by the current call, in Step 618. For example, if the message limit is five calls, messages may only be played every fifth call. If the current call increments the call count to 5, then the call count is met in Step 618. A message may then be played in Step 614, after which, the call may proceed in an ordinary manner in Step 620. If the call count does not equal the message limit, then no message is played and the call proceeds in an ordinary manner, in Step 620. Information server 32 may increment the call count in the subscriber profile or sub-profile, and determine if the current call count meets the message limit, for example.

The ability to identify individual parties to an account via voiceprints also enables the separate tracking of the calls of each subscriber to the account, facilitating more individual customer service and marketing. For example, the concierge requests of each subscriber in an account may be separately tracked and particular types of messages (advertising) geared towards those types of requests may be provided.

As discussed above, use of a PIN to identify a particular member of an account for billing and other purposes, is problematic. In accordance with another embodiment of the invention, the attribution of individual calls by each member of a joint account may be simplified by the use of voiceprints. When a particular subscriber of an account including multiple subscribers calls system 10, that individual may be identified by their voiceprint. Once identified, an identifier of the individual may be inserted into a call detail record (“CDR”) for that communication. A billing record and/or a bill including the identifier may be readily prepared based on the CDR. A subscriber may also request that certain other subscribers to the account be grouped (such as the children in a family), while others (such as each parent) are listed separately.

As discussed above, the CDR is provided to billing platform 50, that correlates other CDRs for that call, as well as CDRs for other calls attributed to a particular account, in preparation for bill generation. In a bill for a joint account, calls attributable to each party to the account are thereby identified and may be listed separately. The identifier of each individual may be a name of the subscriber, a nickname, a PIN or other such number assigned to or selected by each subscriber, a phone number of the phone used to call the system or a department number of a business, for example. The identifier may be inserted into a CDR by voiceprint gateway 132, for example. The billing platform may be part of the system 10, a network carrier or part of a third party, as discussed above.

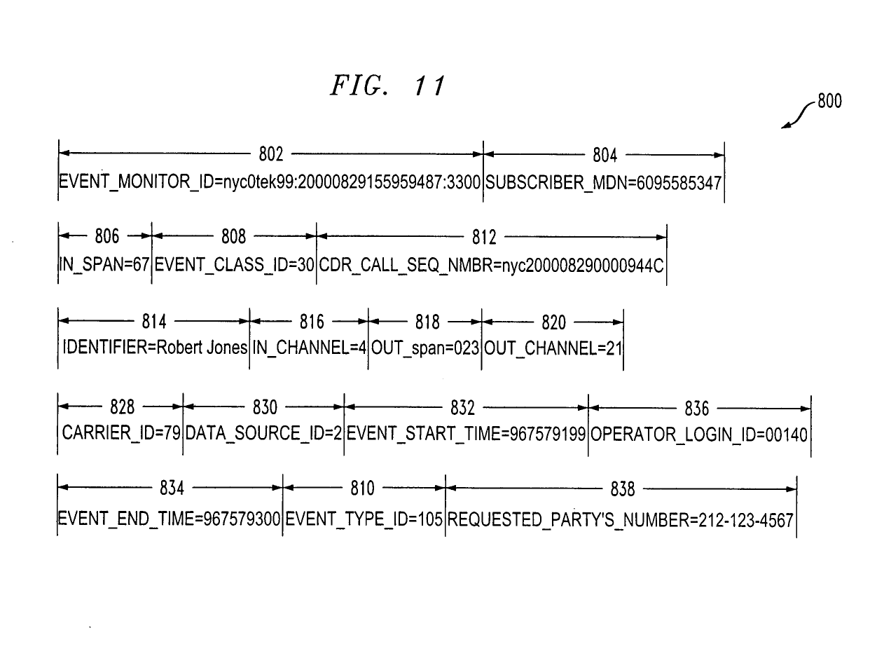

FIG. 10 is an example of a method in accordance with this embodiment of the invention. The account associated with a caller is identified, in Step 702. As discussed above, the account may be identified based on the ANI in the call-setup signals. A voiceprint of the caller is received, in Step 704, by voiceprint gateway 136, for example. If there are multiple parties associated with the account, the identity of the caller is determined based on the voiceprint, in Step 706, as described above with respect to method 600 (FIG. 9), for example. An identifier of the caller is then inserted into a CDR, in Step 708, by voiceprint gateway 136, for example. A bill including the identifier may be generated in step 710.

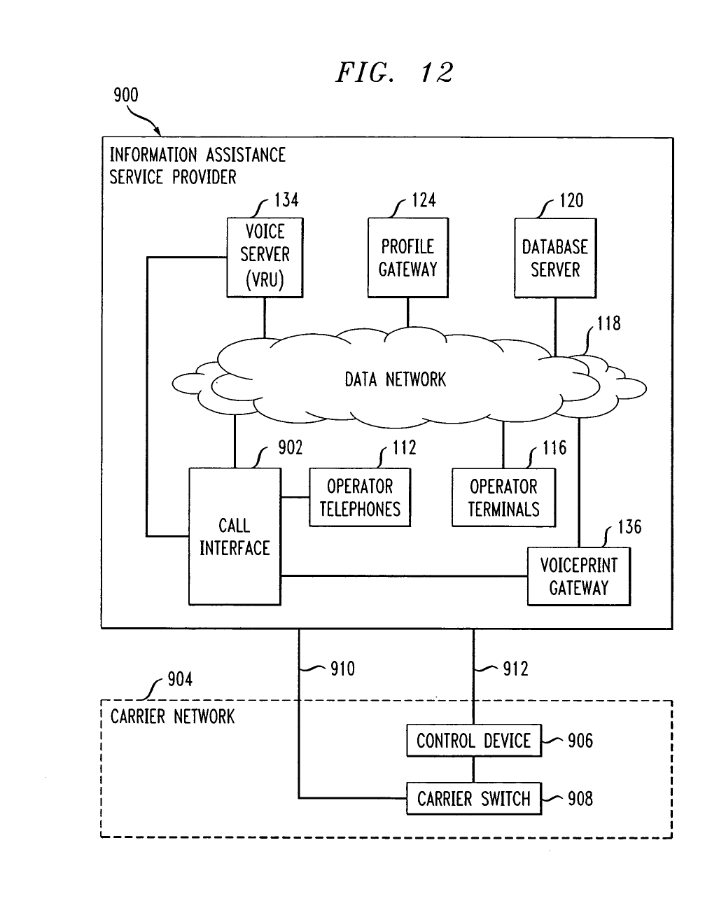

A standard CDR may be readily modified to include a field for such an identifier. FIG. 11 illustrates an example of a CDR 800 that may be generated by voiceprint gateway 136 and IASP 100, for example, to document an identification of a subscriber of a voiceprint information assistance search during an information assistance call. CDR 800 may include multiple fields describing an information assistance communication. Specifically, EVENT_MONITOR_ID field 802 contains a sequence of alphanumeric characters uniquely identifying CDR 800. SUBSCRIBER_MDN field 804 identifies the telephone number of the subscriber who made the information assistance call, i.e., the ANI or MIN. IN_SPAN field 806 identifies the T1 span transporting the incoming communication of the information assistance call.

EVENT_CLASS_ID field 808 is an optional field that may be used to identify a class of an event where CDRs are generated for multiple events, as described in application Ser. No. 09/777,061, discussed above. For example, the value “30” in field 811 in this instance, corresponds to a SEARCHES class. Other values for field 211 may correspond, e.g., to CALL PROCESSING, VALUE ADDED SERVICE and LOCAL SERVICES classes. Another field, here EVENT_TYPE_ID field 810, specifies one of the event types within the class identified by the value in field 808. For example, the value “105” in field 810 in this instance, corresponds to a search for a number of a requested party event within the SEARCHES class. Similarly, other values for field 810 correspond to different types of events in an identified class.

CDR_CALL_SEQ_NMBR field 812 contains a sequence number identifying the information assistance call in question. If multiple event records are generated in the same information assistance communication to document different events taking place during the communication, as described in application Ser. No. 09/777,061, for example, they would share the same value in field 812. In that way, billing compiler 34 may identify and compile event records related to the same communication, as discussed above. Sequence numbers are generated and assigned by switch host computer 108, when the information assistance call is initially received by servicing switch 106. Host computer 108 then transmits the sequence number to switch 106, and any other component in IASP 100 that may generate an event record. For example, the sequence number for a call may be transmitted to operator terminal 116, voice server 134 and database server 120 to be incorporated in any CDR they generate, for that particular call.

In accordance with this embodiment of the invention, IDENTIFIER field 814 contains an identifier of the subscriber calling the system in that call. As described above, when there are multiple parties to an account, such as family members or business employees, the individual subscriber making the call may be identified by their voiceprint. The identifier may be the name, nickname or password of the calling party, a business department or division, etc.

IN_CHANNEL field 816 identifies the channel (within the T1 span identified by IN_SPAN field 406 described above), which the incoming communication of the information assistance call traverses. OUT_SPAN field 818 identifies the T1 span transporting the outgoing communication of the information assistance call, if any. OUT_CHANNEL field 820 identifies the channel (within the T1 span identified by field 818) which the outgoing communication of the information assistance call traverses, if the communication is connected to the requested party's communications number, for example.

CARRIER_ID field 828 identifies the network carrier used to connect the call. For example, the value “79” in field 828 identifies AT&T Corp. as the carrier in this instance. DATA_SOURCE_ID field 830 identifies the component of IASP 100 generating record 800. EVENT_START_TIME field 832 indicates the start time of the communication event in question. It should be noted that the value in field 832 corresponds to a UNIX “epoch” time, i.e., the number of seconds elapsed from Jan. 1, 1970. Similarly, EVENT_END_TIME field 834 indicates the end time of the event in question. Thus, with such event start and end times, the duration of the event in question can be determined, which may be used in computing charges for that call. OPERATOR_LOGIN_ID field 836 identifies the operator handling the event. The REQUESTED_PARTY'S_NUMBER field 838 may contain the retrieved number of the requested party.

Records of events that occurred in a call may be correlated by the same sequence identification number, such as CDR_CALL_SEQ_NMBR field 812. Each information assistance call is associated with customer information, such as ANI or SUBSCRIBER_MDN field 804 information and/or a customer identification number assigned by the carrier.

Other fields, different fields and fewer fields may be provided in CDR 800, as desired or needed by the system 10.

CDR 800 includes all the information necessary for computation of charges for each call, so that bill processing may be readily performed. An additional field or fields may be provided in the bill for indicating the identifier of the party making a particular call. Calls attributable to particular parties to an account may be listed separately in a bill for an account under the identifier of that party or each call may indicate the identifier of the party making the call. A bill may be readily formatted to provide such a field by CDR server 36 or by information server 32, for example.

In addition, IASP 100 may be configured differently from the configuration of FIG. 2. FIG. 11 is an example of an alternative IASP 900. Components common to IASC 100 are commonly numbered. In IASP 900, call interface 902 is not connected to servicing platform 104, as in IASP 100. Instead, the functionality of servicing platform 104 principally is carried out in carrier network 904. Control device 906 in network 904 performs similar functions to switch host computer 108, and carrier switch 908 performs not only its conventional carrier switching functions, but also those of servicing switch 106 described above, under control of device 906.

In IASP 900, a communication, such as an information assistance call, is recognized by control device 906 when it is routed through carrier switch 908. Device 906 causes the communication to be connected through one of pre-designated direct inward dial (DID) connections 910 to provider 900. Control device 906 may also be connected to IASP 900 via an Internet connection 912. The communication is received by call interface 902 therein. Interface 902, connected to operator telephones 112, includes the aforementioned ACD logic for distributing the call to an operator at one of telephones in a conventional manner. Calls are handled in the same manner as described above. The embodiments of the present invention are applied in a system including one or more IASPs 900, in the same manner as described above.

The communications systems described above may be implemented with in-band, feature group D (FGD) type signaling, SS7 out-of-band signaling or other signaling for communications between switches (including carrier switches). Where SS7 out-of-band signaling is used, the communications systems receive the call set-up signals and call progress information (busy, ring-no-answer, number unavailable, answer supervision, etc.) coming from an SS7 signaling link, separate from the voice trunk.

While in the description above, the communications system 10 is said to be an information assistance system, the present invention may be used in other types of voice communications systems that are subscription based and/or include accounts with multiple parties.

The communications systems and their components are disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

The foregoing merely illustrates the principles of the invention. It will thus be appreciated that those skilled in the art will be able to devise numerous other arrangements that embody the principles of the invention and are thus within the spirit and scope of the invention, which is defined by the claims, below.

1-16 (cancelled).

17. A method of operating a communications system, wherein a plurality of users of the system may be associated with an account with the system and the account has a plurality of voiceprint samples corresponding to at least some of the plurality of users associated with the account, the method comprising:
receiving a call from one of a plurality of users associated with an account; and
inserting an identifier of the one of the plurality of users into an event record for the call, based, at least in part, on a voiceprint of the user.

18. The method of claim 17, further comprising:
identifying a profile of the user based, at least in part, on the voiceprint.

19. The method of claim 17, wherein the identifier is at least one of a name of the user, a personal identification number of the user, a business department name and a business department number.

20. The method of claim 17, further comprising:
inserting an identifier indicative of the user and at least one other user associated with the account.

21. The method of claim 17, further comprising:
identifying the account associated with the user based, at least in part, on signals received in establishing the call.

22. The method of claim 17, further comprising:
sending the event record to a billing platform.

23. The method of claim 22, comprising:
sending the event record to a billing platform that is part of the system or part of a third party.

24. The method of claim 22, further comprising:
generating a billing record based on compiled event records, wherein calls are allocated to respective identifiers.

25. The method of claim 22, further comprising:
receiving a billing record from the billing platform, wherein calls are allocated to respective identifiers.

26. The method of claim 25, further comprising:
generating a bill for an account wherein individual calls are allocated to respective identifiers.

27. The method of claim 17, further comprising:
providing information assistance to the user.

28. A communications system, wherein a plurality of users of the system may be associated with an account with the system and the account has a plurality of voiceprint samples corresponding to at least some of the plurality of users associated with the account, the system comprising:
an interface to receive signals to establish a call connection with a user; and
a processor coupled to the interface, the processor programmed to:
insert an identifier of the one of the plurality of users into an event record for the call, based, at least in part, on a voiceprint of the user received in the call.

29. The system of claim 28, wherein the processor is further programmed to:
identify a profile of the user based, at least in part, on the voiceprint.

30. The system of claim 28, wherein the identifier is at least one of a name of the user, a personal identification number of the user, a business department name and a business department number.

31. The system of claim 28, wherein the processor is further programmed to:
identify an account associated with the user based, at least in part, on signals received in establishing the call.

32. The system of claim 28, wherein the processor is further programmed to:
send the event record to a billing platform.

33. The system of claim 28, wherein the processor is further programmed to:
generate a bill for an account wherein individual calls are allocated to respective identifiers based on a billing record from the billing platform.

34-85 (cancelled).
